(19) United States
(12) Patent Application Publication
(10) Pub. No.: US 2016/0167308 A1
(43) Pub. Date: Jun. 16, 2016

(54) SYSTEMS AND METHODS FOR PROTOTPYE REFINEMENT AND MANUFACTURE IN 3D PRINTING

(71) Applicant: eBay Inc., San Jose, CA (US)

(72) Inventors: Dane Glasgow, Los Altos, CA (US); Corinne Elizabeth Sherman, San Jose, CA (US); Matthew Bret MacLaurin, Santa Cruz, CA (US)

(21) Appl. No.: 14/572,624

(22) Filed: Dec. 16, 2014

(51) Int. Cl. B29C 67/00; G05B 19/4099

(52) U.S. Cl. CPC B29C 67/0088; G05B 19/4099; B33Y 10/00

(57) ABSTRACT

Systems, methods, and media for 3D prototype printing are provided. In one example, a system comprises at least one module, executing on one or more computer processors, configured to store data relating to an item of sports equipment for test use by a user; use one or more sensors to capture data relating to the use of the item of sports equipment by the user; based on the captured data, facilitate identification of a modification to the item of sports equipment to optimize, compensate for, or correct the use of the item of sports equipment by the user; create a 3D digital model of the item of sports equipment based on the identified modification; and transmit data relating to the 3D digital model to a 3D printer to create a further prototype or final version of the item of sports equipment incorporating the identified modification.

### TECHNICAL FIELD

The present application relates generally to the technical field of three dimensional (3D) printing and, in particular, to the design and manufacture of prototypes for testing or trial purposes, for example in sports equipment personalization and performance enhancement.

### BACKGROUND

Additive manufacturing, or 3D printing, is a process of making a three-dimensional solid object of virtually any shape from a digital model. 3D printing is achieved using an additive process, where successive layers of material are laid down in different shapes. 3D printing is considered distinct from traditional machining techniques, which mostly rely on the removal of material by methods such as cutting or drilling (subtractive processes).

3D printing technology can be used in distributed manufacturing with applications in architecture, construction (AEC), industrial design, automotive, aerospace, and many other fields.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a schematic diagram of a 3D prototype printing services platform, in accordance with some embodiments;

FIG. 2 illustrates example elements for inclusion in a graphical user interface, in accordance with some embodiments;

FIG. 3 is a schematic diagram of 3D prototype printing services channels, in accordance with some embodiments;

FIG. 4 is a network diagram depicting an example system, in accordance with some embodiments;

FIG. 5 is a block diagram depicting additional details of the example system of FIG. 4, in accordance with some embodiments;

FIG. 6 is a flowchart illustrating example method operations, in accordance with some embodiments; and

FIG. 7 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail. In this specification the terms “user” and “participant” are used interchangeably unless the context indicates otherwise.

Many sports and other activities require the purchase of expensive gear or equipment. While a user may initially possess the gear to learn the sport, he or she might not yet be proficient enough in the sport or activity to take advantage of that gear, or its enhanced features. Further, each user might have subtle differences in how they ride a bike or surfboard, swing a golf club, and so forth that could be unique to that user. In broad terms, the present disclosure relates to a system and method for prototype printing services. In one example, a user starts with a “generic” item of sports gear or equipment (also termed an “initial” prototype) that has sensors embedded in or associated with it which can detect or measure the user's unique habits or tendencies (“traits”) in using that gear or equipment. The traits may be small or visually imperceptible to the naked eye. Adjustments to the item to compensate for or correct the user's traits are identified and a 3D digital model of the adjusted item is created for digital printing. The creation of the digital model may (or may not) include scanning the adjusted generic item (e.g. a golf driver head with additional volume or weights added to it), or other digital input techniques.

A “real-life” version of the adjusted item is then 3D printed as a second or further prototype (also termed an “iterative” prototype) specifically designed to compensate for or correct the user's traits. The process continues with creating and 3D printing further digital models of prototypes and re-testing them in use until the user has achieved a sufficient degree of proficiency in the sport or activity (more specifically in using the item in question) and is ready to purchase a final item (also termed the “final” prototype) that they will likely use for a long time. In some examples, the final item is of more expensive, more permanent, or superior construction compared to the generic item. In some examples, the user may not purchase or take possession of the actual “final prototype” but may select or buy a final item based on one or more attributes or aspects of the final prototype. The systems and methods described herein may be employed by users such as sports outlets, coaching clinics, manufacturers, sports clubs, or the like. Although the examples described in this specification relate to the iterative manufacture and design of prototypes of sports gear or equipment, it will be appreciated that the described systems and methods could be used in other applications.

In some embodiments, a three-dimensional (3D) printing marketplace is created in which 3D printing service providers can fulfil requests for 3D printing tasks, such as prototype manufacture. In some examples, a 3D printing marketplace allows marketplace participants such as CAD designers, sports manufacturers, engineers, sports consumers, and so forth to upload generic, prototype, or final designs or specifications (generally referred to herein as “digital models”) into a marketplace platform, for example hosted by an online retailer or a 3D service provider. In some examples, an upload fee is charged, for example, based on a fixed price, or a variable price based on file size. In some examples, the uploaded designs (digital models) are sent to or displayed to remote 3D service providers participating in the marketplace for 3D printing and manufacture of the various prototypes as described further above. This may be an iterative process, using a local 3D printer or a remote one. The communication or display of the digital models can occur through various communication channels such as web-enabled devices, mobile applications, and the like. In some examples, buyers can select a 3D printing service to print a 3D version of a prototype displayed in digital form. In some examples, 3D service providers can compete or bid to complete a 3D printing task based on a displayed design. Users or 3D service providers can select a printing option associated with the displayed design from an array of available 3D printing options. In some examples, the 3D printing marketplace may have access to a system of federated 3D printing services, or a network of such services. The federated or networked printing services may be ranked and displayed in order of preference or other identified criteria to a buyer. As used in this specification, the term “ranking” includes “listing” and, where appropriate, these terms are used interchangeably.

In one example, a buyer can seek authorization from a digital rights owner or content provider in order to complete submission of, or a request for, a digital model of a prototype for 3D printing (e.g. Wilson™ Gold Driver head). As used herein, the term “digital rights” refers to the human or other rights that allow individuals or entities to access, use, create, reproduce, and publish digital media or to access and use computers, other electronic devices, or communications networks. The term is particularly related to the protection and realization of existing rights, such as copyright or other designs rights vesting in a three-dimensional article, and includes rights in or to a digital model of that three-dimensional article or adaptations of it. An owner of digital rights may for example be an original proprietor of such rights, an author, a designer, or a licensee or transferee of such rights. The term “digital rights” is not intended to be limiting, and the reference to an owner of digital rights in a 3D object is intended to include any entity having rights to create, use, or reproduce that 3D object. An owner may authorize others to use the digital rights vesting in a 3D object or a digital model of the object.

In some examples, unless authorized, a buyer is restricted from using any 3D printing services to 3D print the digital model. In some cases a buyer may be limited in the number of 3D models authorized for replication by 3D printing. In some examples, a digital rights owner may pre-authorize replication of a digital model for 3D printing in exchange for payment by the buyer of a royalty or other fee. The pre-authorization to print a specified digital model may be published to the 3D printing marketplace at large. The pre-authorization can be represented or embodied in the marketplace in various forms as discussed further below. A payment for royalty fees may be collected by a participant in the 3D marketplace, such as a 3D printing service provider, a retail merchant (for example, a toy store or Disney™ channel outlet), or an electronic storefront, for example. Other royalty collection entities are possible. In some examples, a royalty payment or authentication fee is included in a service charge for 3D printing services.

In some examples, buyers can select an available 3D printing option or customize a design or digital model for 3D printing and, in some examples, may have multiple choices in buying the design or model, buying rights to the design or model, or 3D printing the design or model. In some examples, printing options for a buyer can include downloading a design file (or digital model) for their own use; requesting printing services limited to 3D variants only; and requesting shipment of a 3D printed object to a buyer address, in which event, for example, a 3D printing service could print and ship the 3D object from its own facility. The printing options could include requesting expedited shipment of a 3D printed object to a buyer address the same day (for example, using a “print now” facility), or requesting collection of a 3D printed object from a nearby 3D printing kiosk or mobile facility such as a 3D printing van, for example. In some examples, the 3D kiosk or mobile facility may form part of the federated or networked system of 3D printing services discussed further above.

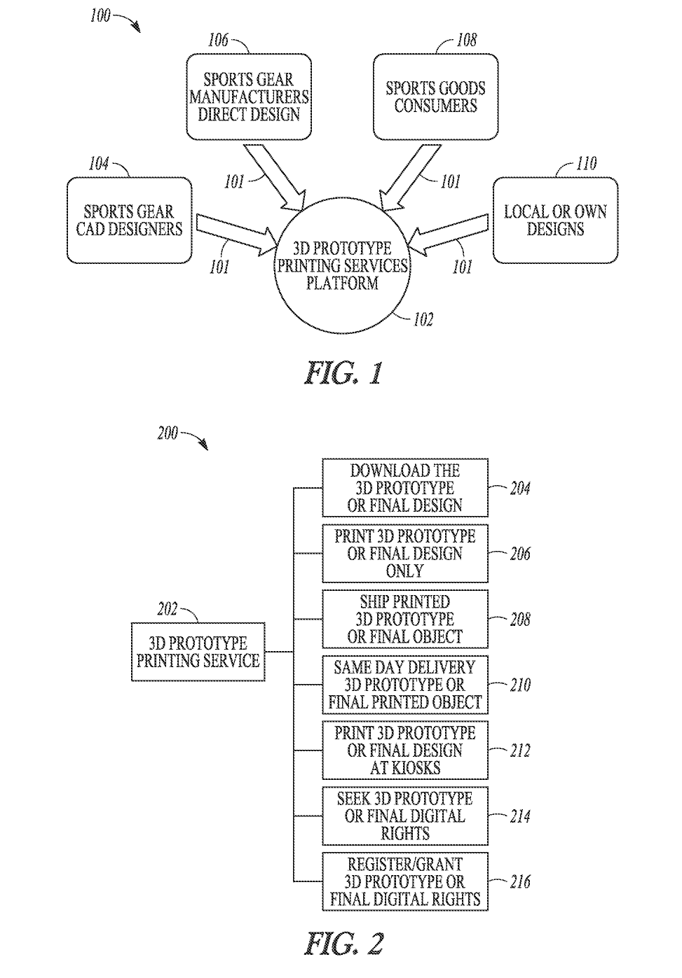

Referring now to FIG. 1 of the accompanying drawings, participants in an online or electronic 3D printing marketplace environment, generally designated 100, can, at operations 101, submit or upload designs or specifications (digital models) for 3D printing into a marketplace selling platform, such as a 3D prototype printing services platform 102. The marketplace participants can include, for example, sports gear or equipment designers 104 (often using CAD techniques), sports gear manufacturers (having direct or original designs, for example) 106, consumers (individual sports-men or -women, sports shops, retail outlets, and so forth, typically using proprietary designs of the sports gear designers 104 or manufacturers 106 in the iterative prototype process) 108, and other entities (e.g. local surf shop or coaching clinic) 110 perhaps creating their own 3D designs or digital models. Other examples of marketplace participants are possible. In some examples, the participants own rights to the digital models submitted to the 3D prototype printing services platform 102 and the printed 3D objects based on such models.

In some examples, an online 3D printing service (or online retailer, for example) presents an interface in the marketplace, which displays various 3D printing service options, including different ways of selecting and purchasing these services. In some examples, an interface includes a portal allowing a user (buyer) to obtain access to or pay for authorization to 3D print a digital model from a digital rights owner. In some examples, a portal is provided allowing the owner of rights in a digital model to register those rights, or authenticate or grant permission for 3D printing of the model. In some examples, a digital rights owner can prevent 3D printing of a digital model or restrict the number of copies made. A monitoring or gate-keeper function for the 3D printing of digital models can be enabled by the printing service or marketplace host, for example.

With reference to FIG. 2 of the accompanying drawings, an example interface 200 displayed by a 3D prototype printing service of the type described above (having aspects in the real-life or virtual worlds) may include, among other elements, an access link 202 and/or another type of visual or audible media suitable for an electronic storefront, mobile application interface, or website. In the example interface 200, and in relation to a generic item, one or more iterative prototypes, or a final item, user interface elements, such as “download the 3D design” 204, “print 3D design only” 206, “ship printed 3D object” 208, “same day delivery 3D printed object” 210, and “print 3D design at kiosks” 212 are provided. In some examples, “seek 3D digital rights” 214 and/or “register/grant 3D digital rights” 216 user interface elements are provided. In some examples, further user interface elements are provided, allowing a buyer to select a check out flow using a third party payment service provider. The interface 200 is merely an example. The advertisement banner 202 and user interface elements 204-216 are merely examples. Other examples of user interfaces and interface elements are possible.

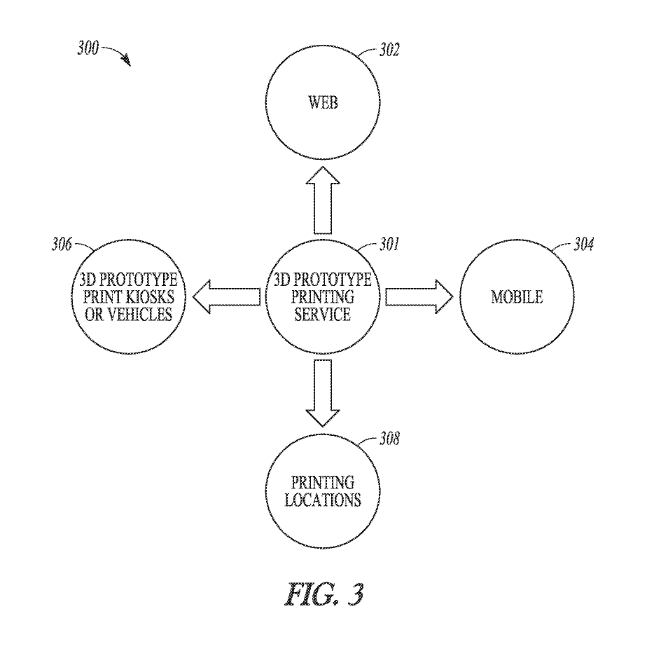

With reference to FIG. 3, example 3D prototype printing service channels in a 3D prototype printing marketplace environment 300 can include a 3D prototype printing service 301, web channels 302, mobile channels or applications 304, 3D prototype printing kiosks or vehicles 306, and prototype printing locations 308. The kiosks or vehicles 306 and prototype printing locations 308 may be branded by a major sports retailer, 3D service provider, or electronic marketplace host, for example.

In some examples, a 3D printing certification device (a symbol, graphic mark or word, brand, or trademark, for example) is displayed in a user interface associated with the 3D prototype printing service 301 to attest to or confirm that authorized 3D printing rights have been granted to a certain 3D prototype printing service 301, or other marketplace participant offering or engaged in the provision of 3D printing services. The device may be encrypted or made special in an appropriate manner so that the granting of genuine rights in digital models can be certified or assured. In some examples, use of the device or proxy by a 3D printing service provider (or other marketplace participant) can be restricted by the digital rights owner in relation to at least one aspect, for example, relating to a defined period, a geographic location or territory, defined buyers, defined 3D printed objects, defined uses, defined characteristics, and so forth. The restrictions may, for example, be based on a compliance with domestic or international statutes, regulations, contractual rights, safety laws, gun rights legislation, constitutional freedoms, and so forth.

In some examples, an owner of digital rights may authorize a printing service, marketplace host, or other marketplace participant to allow 3D printing of proprietary digital models based on acceptance by the 3D prototype printing service 301 or a buyer of certain terms and conditions. The authorization may be a pre-authorization or provided on demand, in some examples. The terms and conditions can be presented to a buyer in the course of the buyer selecting various example 3D printing options, such as those discussed further above. Payment for access to or exercise of granted digital rights, in addition to payment for 3D printing services, can also be enabled and presented to a buyer in the course of a check out flow. To this end, one or more third party payment services provider may be employed. A cost model can be created, for example, based on a purchase or delivery option selected by a buyer in a check out flow. In some examples, money flows or royalty streams due to a digital rights owner can be separated from income derived from the purchase of 3D printing services. Authentication devices may be employed to manage the exercise of digital rights, and some examples are discussed below.

In some examples, digital rights to brands, TV channels, movie rights, and other entertainment media are authorized and managed using the systems, methods, and media described herein. For example, a 3D certification device in an interface managing requests and authorization to print 3D versions of Taylormade™ golf clubs might include a depiction of a branded driver head or other logo. The depiction may include two- or three-dimensional views of the branded driver head, or a hologram effect, for example. The certification symbol may be associated with code or other credentials submitted to a 3D printing machine. The code or credentials may relate to specific modes, codes, or numbers of 3D printing authorized by the digital rights owner. The code or other credentials may accompany a 3D printing request or instructions sent to a 3D printing facility, for example. The printing facility may be a kiosk or mobile 3D printing van, as discussed above. A great variety of 3D printing orders can be facilitated and fulfilled while preserving the rights of digital rights owners.

As mentioned above, the 3D prototype printing marketplace may include or have access to a system of federated 3D prototype printing services 301. The federated 3D prototype printing services 301 may be ranked by a sports goods or credentialing authority, for example, and displayed in order of user preference or based on other criteria identified by a user or marketplace participant.

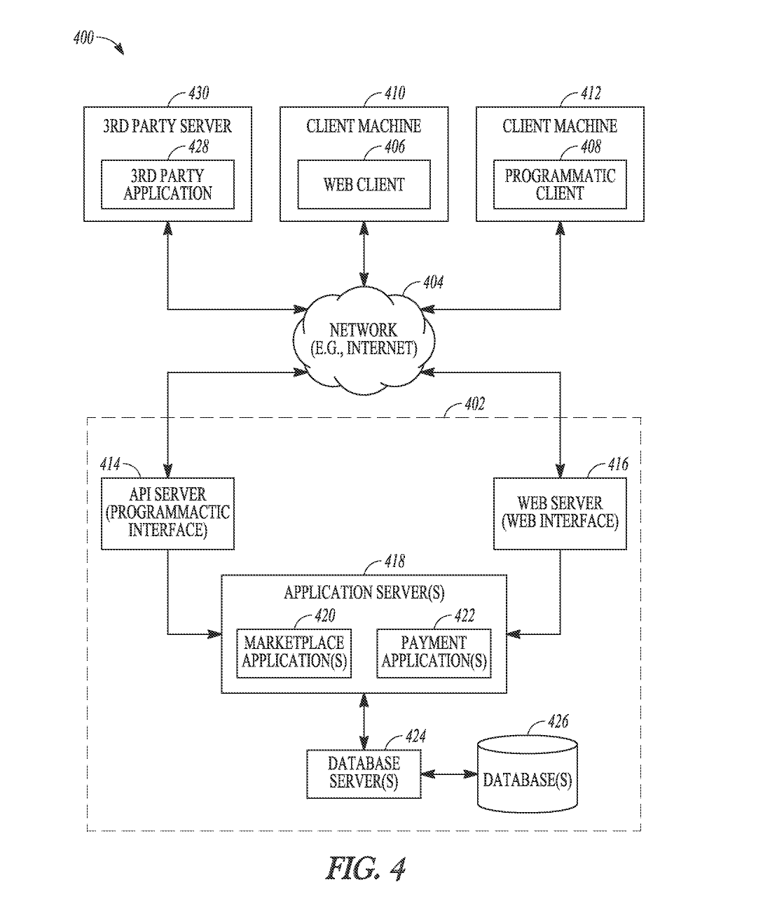

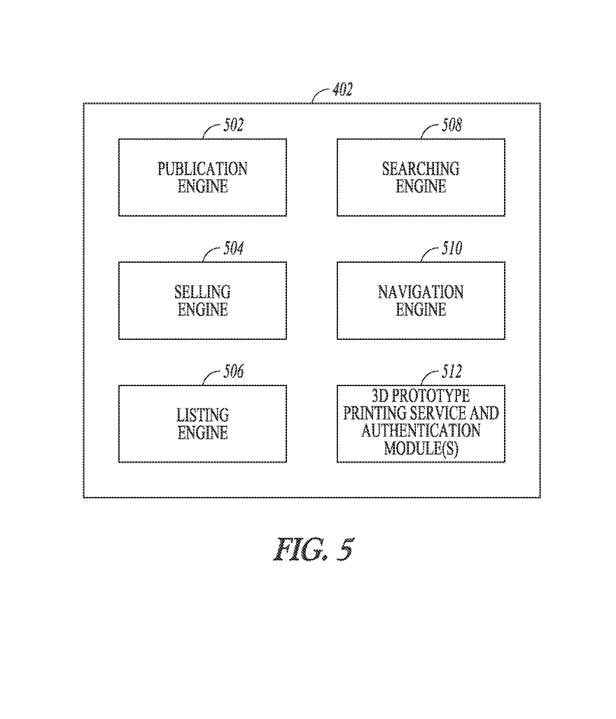

Turning now to the accompanying drawings, FIG. 4 is a network diagram depicting an example system 400 for facilitating 3D prototype printing services provided in a 3D prototype printing service marketplace, according to some embodiments. A networked system 402 provides server-side functionality, via a network 404 (e.g., the Internet or a wide area network (WAN)), to one or more clients and devices. FIG. 4 further illustrates, for example, one or both of a web client 406 (e.g., a web browser) and a programmatic client 408 executing on client machines 410 and 412, respectively. In one embodiment, the system 400 comprises a marketplace system. In another embodiment, the system 400 comprises other types of systems such as, but not limited to, a social networking system, a matching system, an electronic commerce (e-commerce) system, and the like.

Each of the client machines 410, 412 comprises a computing device that includes at least a display and communication capabilities with the network 404 to access the networked system 402. The client machines 410, 412 comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the client machines 410, 412 may connect with the network 404 via a wired or wireless connection. For example, one or more portions of the network 404 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network 404, or a combination of two or more such networks 404.

Each of the client machines 410, 412 includes one or more applications (also referred to as “apps”) such as, but not limited to, a web browser, messaging application, electronic mail (email) application, c-commerce site application (also referred to as a marketplace application, including 3D printing service applications), and the like. In some embodiments, if the e-commerce site application is included in a given one of the client machines 410, 412, then this application is configured to locally provide the user interface and at least some of the functionalities, with the application configured to communicate with the networked system 402, on an as-needed basis, for data and/or processing capabilities not locally available (such as to access a database of items available for sale or 3D printing services available, to authenticate a user, to verify a method of payment, etc.). Conversely, if the e-commerce site application is not included in a given one of the client machines 410, 412, the given one of the client machines 410, 412 may use its web browser to access the e-commerce site (or a variant thereof) hosted on the networked system 402. Although two client machines 410, 412 are shown in FIG. 4, more or fewer than two client machines can be included in the system 400.

An application program interface (API) server 414 and a web server 416 are coupled to, and provide programmatic and web interfaces respectively to, one or more application servers 418. The application servers 418 host one or more marketplace applications 420 and payment applications 422. The marketplace applications 420 can include 3D printing service applications. The application servers 418 are, in turn, shown to be coupled to one or more database servers 424 that facilitate access to one or more databases 426.

The marketplace applications 420 may provide a number of e-commerce functions and services to users who access the networked system 402. E-commerce functions and services may include a number of publisher functions and services (e.g., search, listing, content viewing, payment, etc.). For example, the marketplace applications 420 may provide a number of services and functions to users for listing goods and/or services or offers for goods and/or services for sale, searching for goods and services, facilitating transactions, and reviewing and providing feedback about transactions and associated users. The services can include 3D prototype printing services. Additionally, the marketplace applications 420 may track and store data and metadata relating to listings, transactions, 3D service providers, rankings, and user interactions. The data can include digital rights data, digital rights certification and registration data, and digital model and 3D object verification data of the type discussed elsewhere in this specification. In some embodiments, the marketplace applications 420 may publish or otherwise provide access to content items stored in the application servers 418 or databases 426 accessible to the application servers 418 and/or the database servers 424.

The payment applications 422 may likewise provide a number of payment services and functions to users. The payment applications 422 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 420. The payment applications 422 may regulate payment to sellers for goods and/or services sold in the marketplace and direct a portion of the proceeds to a marketplace controller for use of susceptibility profiles for boosting the conversion of sales. The payment applications 422 may allow collection or payment of royalty fees and the like for use of digital rights associated with requests or fulfilment of 3D printing tasks. The payment applications 422 may be configured or coded to allow any of the money-related operations, functions, and method steps discussed within the present disclosure.

While the marketplace and payment applications 420 and 422 are shown in FIG. 4 to both form part of the networked system 402, it will be appreciated that, in alternative embodiments, the payment applications 422 may form part of a payment service that is separate and distinct from the networked system 402. In other embodiments, the payment applications 422 may be omitted from the system 400. In some embodiments, at least a portion of the marketplace applications 420 may be provided on the client machines 410 and/or 412.

Further, while the system 400 shown in FIG. 4 employs a client-server architecture, embodiments of the present disclosure are not limited to such an architecture, and may equally well find application in, for example, a distributed or peer-to-peer architecture system. The various marketplace and payment applications 420 and 422 may also be implemented as standalone software programs, which do not necessarily have networking capabilities.

FIG. 4 also illustrates a third party application 428, executing on a third party server machine 430, as having programmatic access to the networked system 402 via the programmatic interface provided by the API server 414. For example, the third party application 428 may, utilizing information retrieved from the networked system 402, support one or more features or functions on a website hosted by a third party. The third party website may, for example, provide one or more promotional, marketplace, 3D prototype printing service, or payment functions that are supported by the relevant applications of the networked system 402.

FIG. 5 is a block diagram showing components provided within the networked system 402, according to some embodiments. The networked system 402 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 426 via the database servers 424.

The networked system 402 may provide a number of publishing, listing, and/or price-setting mechanisms whereby a seller (also referred to as a first user) may list (or publish information concerning) goods or services (including 3D printing services) for sale or barter, a buyer (also referred to as a second user) can express interest in or indicate a desire to purchase or barter such goods or services, and a transaction (such as a trade) may be completed pertaining to the goods or services. To this end, the networked system 402 may comprise at least one publication engine 502 and one or more selling engines 504. The publication engine 502 may publish information, such as item or service listings or product description pages, on the networked system 402. In some embodiments, the selling engines 504 may comprise one or more fixed-price engines that support fixed-price listing and price setting mechanisms. A listing engine 506 allows sellers to conveniently author listings of items or authors to author publications. In one embodiment, the listings pertain to goods or services including 3D prototype printing services of the type described herein.

Searching the networked system 402 is facilitated by a searching engine 508. For example, the searching engine 508 enables queries of listings published via the networked system 402, including 3D prototype printing service listings. In example embodiments, the searching engine 508 receives the queries from a device of a user (e.g. any of the entities mentioned with reference to FIG. 1) and conducts a review of the storage device storing the listing information. The review will enable compilation of a result set of listings that may be sorted and returned to the client device (e.g., client machine 410, 412) of the user. The searching engine 508 may record the query (e.g., keywords) and any subsequent user actions and behaviors (e.g., navigations).

The searching engine 508 also may perform a search based on the location of the user. A user may access the searching engine 508 via a mobile device or other computer and generate a search query. Using the search query and the user's location (e.g. sports retail store), the searching engine 508 may return relevant search results for products, services, offers, and so forth related to 3D prototype printing to the user. The searching engine 508 may identify relevant search results both in a list form and graphically on a map. Selection of a graphical indicator on the map may provide additional details regarding the selected search result. In some embodiments, the user may specify a radius or distance from the user's current location as part of the search query in order to limit search results.

The searching engine 508 also may perform a search based on an image. The image may be taken from a camera or imaging component of a client device or may be accessed from storage. The image may relate to an item of sports equipment, for example.

In a further example, a navigation engine 510 allows users to navigate through various categories, catalogs, or inventory data structures according to which listings of 3D prototype printing services may be classified within the networked system 402. For example, the navigation engine 510 allows a user to successively navigate down a category tree comprising a hierarchy of categories (e.g., the category tree structure) until a particular set of listings is reached. Various other navigation applications within the navigation engine 510 may be provided to supplement the searching and certain browsing applications. The navigation engine 510 may record the various user actions (e.g., clicks) performed by the user in order to navigate down the category tree.

In some embodiments, a 3D prototype printing service and authentication module(s) 512 may be configured to create and implement the 3D prototype printing service 301, certification, registration, verification, and other functions and methods described in this specification. It is contemplated that the 3D prototype printing service and authentication module(s) 512 may be further configured to provide or perform any of the features, functions, methods, or operations related to 3D prototype printing systems and methods described herein.

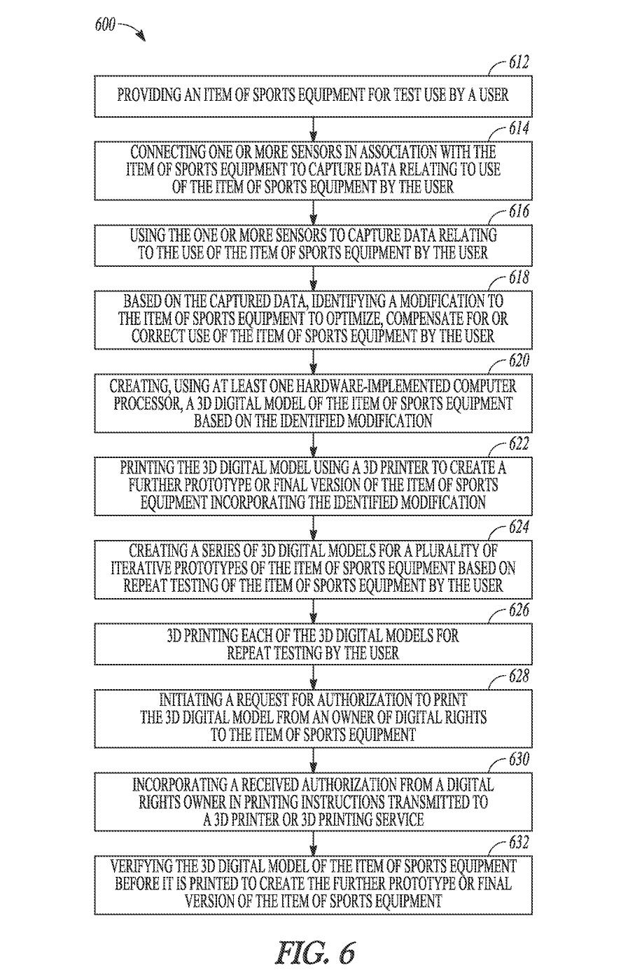

Some of the embodiments disclosed herein include methods. FIG. 6 is a flowchart illustrating a method 600 for 3D prototype printing services. Some of the operations of the method 600 may be performed by the client machine 410, the client machine 412, and/or a server included in the networked system 402 (e.g., API server 414, web server 416, or application servers 418). Some of the operations may be performed by one or more modules (e.g., 3D prototype printing service and authentication module(s) 512). The various operations of the method 600 may be performed in different orders, and the method 600 may include only some of the operations described below.

The method 600 may comprise, at operation 612, providing an item of sports equipment for test use by a user; at operation 614, connecting one or more sensors in association with the item of sports equipment to capture data relating to use of the item of sports equipment by the user; at operation 616, using the one or more sensors to capture data relating to the use of the item of sports equipment by the user; at operation 618, based on the captured data, identifying a modification to the item of sports equipment to optimize, compensate for, or correct use of the item of sports equipment by the user; at operation 620, creating, using at least one hardware-implemented computer processor, a 3D digital model of the item of sports equipment based on the identified modification; and, at operation 622, printing the 3D digital model using a 3D printer to create a further prototype or final version of the item of sports equipment incorporating the identified modification.

The method 600 may further comprise, at operation 624, creating a series of 3D digital models for a plurality of iterative prototypes of the item of sports equipment based on repeat testing of the item of sports equipment by the user. The method 600 may further comprise, at operation 626, 3D printing each of the 3D digital models for repeat testing by the user.

In some examples, creating the 3D digital model of the item of sports equipment based on the identified modification further comprises, at operation 628, initiating a request for authorization to print the 3D digital model from an owner of digital rights to the item of sports equipment. At operation 630, a received authorization from a digital rights owner may be incorporated in printing instructions transmitted to a 3D printer or 3D printing service.

In another example, the method 600 further comprises, at operation 632, verifying the 3D digital model of the item of sports equipment before it is printed to create the further prototype or final version of the item of sports equipment.

These and other variations in the performance of the method 600 are within the scope of embodiments of the present disclosure.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 404 of FIG. 4) and via one or more appropriate interfaces (e.g., APIs).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computing system can include clients and servers. A client and server are generally remote from each other and typically interact through a network 404. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

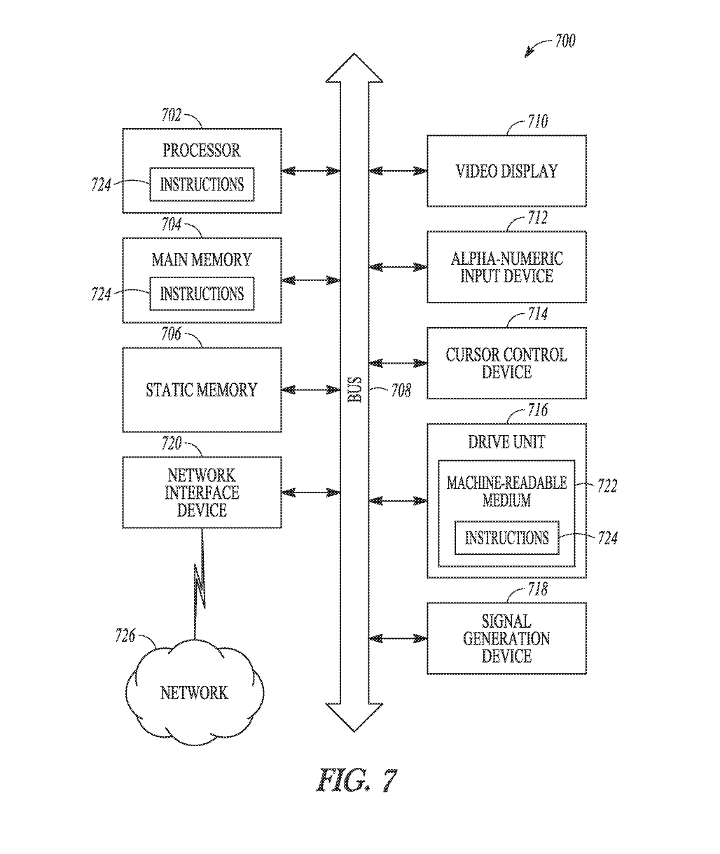

FIG. 7 is a block diagram of a machine in the example form of a computer system 700 within which instructions 724 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions 724 (sequential or otherwise) that specify actions to be taken by that machine. Further, while only a single machine is illustrated, the term “machine” shall also be taken to include any collection of machines that individually or jointly execute a set (or multiple sets) of instructions 724 to perform any one or more of the methodologies discussed herein.

The example computer system 700 includes a processor 702 (e.g., a central processing unit (CPU), a graphics processing unit (GPU), or both), a main memory 704, and a static memory 706, which communicate with each other via a bus 708. The computer system 700 may further include a video display 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker), and a network interface device 720.

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media 722. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding, or carrying instructions 724 for execution by the machine and that cause the machine to perform any one or more of the methodologies of the present embodiments, or that is capable of storing, encoding, or carrying data structures utilized by or associated with such instructions 724. The term “machine-readable medium” shall accordingly be taken to include, but not be limited to, solid-state memories, and optical and magnetic media. Specific examples of machine-readable media 722 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communication network 726 using a transmission medium. The instructions 724 may be transmitted using the network interface device 720 and any one of a number of well-known transfer protocols (e.g., HTTP). Examples of communication networks 726 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 724 for execution by the machine, and includes digital or analog communications signals or other intangible media to facilitate communication of such instructions 724.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
providing an item of sports equipment for test use by a user;
connecting one or more sensors in association with the item of sports equipment to capture data relating to the use of the item of sports equipment by the user;
using the one or more sensors to capture the data relating to the use of the item of sports equipment by the user;
based on the captured data, identifying a modification to the item of sports equipment to optimize, compensate for, or correct the use of the item of sports equipment by the user;
creating, using at least one hardware-implemented computer processor, a 3D digital model of the item of sports equipment based on the identified modification; and
printing the 3D digital model using a 3D printer to create a further prototype or final version of the item of sports equipment incorporating the identified modification.

2. The method of claim 1, further comprising creating a series of 3D digital models for a plurality of iterative prototypes of the item of sports equipment based on repeat testing of the item of sports equipment by the user.

3. The method of claim 2, further comprising 3D printing each of the 3D digital models in the series for repeat testing by the user.

4. The method of claim 1, wherein creating the 3D digital model of the item of sports equipment based on the identified modification further comprises initiating a request for authorization to print the 3D digital model from an owner of digital rights to the item of sports equipment.

5. The method of claim 4, further comprising incorporating a received authorization from the owner of the digital rights in printing instructions transmitted to the 3D printer or a 3D printing service.

6. The method of claim 1, further comprising verifying the 3D digital model of the item of sports equipment before it is printed to create the further prototype or final version of the item of sports equipment.

7. A system comprising:
at least one module, executing on one or more computer processors, configured to:
store data relating to an item of sports equipment for test use by a user;
use one or more sensors to capture data relating to the use of the item of sports equipment by the user;
based on the captured data, facilitate identification of a modification to the item of sports equipment to optimize, compensate for, or correct the use of the item of sports equipment by the user;
create a 3D digital model of the item of sports equipment based on the identified modification; and
transmit data relating to the 3D digital model to a 3D printer to create a further prototype or final version of the item of sports equipment incorporating the identified modification.

8. The system of claim 7, wherein the at least one module is further configured to create a series of 3D digital models for a plurality of iterative prototypes of the item of sports equipment based on repeat testing of the item of sports equipment by the user.

9. The system of claim 8, wherein the at least one module is further configured to transmit data relating to each of the 3D digital models in the series to the 3D printer or a 3D printing service.

10. The system of claim 7, wherein creating the 3D digital model of the item of sports equipment based on the identified modification further comprises initiating a request for authorization to print the 3D digital model from an owner of digital rights to the item of sports equipment.

11. The system of claim 10, wherein the at least one module is further configured to incorporate a received authorization from the owner of the digital rights in printing instructions transmitted to the 3D printer or a 3D printing service.

12. The system of claim 7, wherein the at least one module is further configured to verify the 3D digital model of the item of sports equipment before it is printed to create the further prototype or final version of the item of sports equipment.

13. A non-transitory machine-readable medium including a set of instructions that, when executed by a machine, causes the machine to perform a set of operations including:
storing data relating to an item of sports equipment for test use by a user;
using one or more sensors to capture data relating to the use of the item of sports equipment by the user;
based on the captured data, facilitating identification of a modification to the item of sports equipment to optimize, compensate for, or correct the use of the item of sports equipment by the user;
creating a 3D digital model of the item of sports equipment based on the identified modification; and
transmitting data relating to the 3D digital model to a 3D printer to create a further prototype or final version of the item of sports equipment incorporating the identified modification.
